(19) United States
(12) Patent Application Publication
(10) Pub. No.: US 2004/0071920 A1
(43) Pub. Date: Apr. 15, 2004

(54) Ceramic tesseras for a mosaic which is easy and... pretty

(76) Inventor: Giovanni Ria, Lecce (IT)

Correspondence Address: Hoffman Wasson & Gitler, Suite 522, 2361 Jefferson Davis Highway, Arlington, VA, 22202, US

(21) Appl. No.: 10/469,237

(22) PCT Filed: Mar. 4, 2002
(86) PCT No.: PCT/EP02/02313

(30) Foreign Application Priority Data
Mar. 5, 2001 (IT) LE2001A00009

(51) Int. Cl. G09F 3/00

(52) U.S. Cl. 428/43; 156/89.11; 428/44

(57) ABSTRACT

Allows tesseras to be obtained with optimal results in the creation of a mosaic. A terracota support is realised of an optimal size of 100×100 mm and a thickness of between 1.5 and 3 mm, subject to allowances for working, also by a craftsman, The support 1 made to allowances for working, also by a craftsman The support 1 made out of clay, before firing is scored or moulded on the rear part with grooves which are regular, parallel and perpendicular or oblique, at a distance of betwen 5 and 10 mm (or other, according to requirements) with a depth of between about 0.75 and 1.5 mm. After the first kil firing, one then proceeds to the kiln glazing of the front part 2. The grooves 3 allow an easy and regular breaking of the glazed tile. With its breaking the tesseras are obtained, with perfect edges and the rear part no visible, thanks particular to the reduced thichness. This then allows an easy resizing with side-cutting nippers of the tessera and the adaptation thereof to the design.

The present invention has as its object a new type of coloured tessera for a mosaic, made out of easy-to-use kiln-glazed terracotta for whoever wishes to try one's hand at this ancient technique.

For the material used, the sizes and the chromatic outcome, the tesseras object of the present description guarantee a result with an effect which is certain, with a low production cost and a truly exceptional workability for the artist.

Nowadays the mosaic is realised with a large number of materials and many can be given as an example: coloured paper, marble, coloured glass, pebbles, fragments of crockery, different coloured limestone like Verona Red, Botticino White, green of the Alps or prealpine greys, shells, etc. The prettiest tesseras, however, are those made of enamel, with bright and full colours, with undeniable shine and brightness. Enamels for mosaics are nowadays difficult to get hold of and are very expensive. They are, hence, materials for professional use which are advised against by experts to whoever should be taking their first steps in this art.

Currently, to obtain a mosaic with so important chromatic characteristics, professionals had to form the tesseras, from rounded disks of enamel, with a thickness of about one centimetre and a diameter of at least one hand's span. It is clearly very difficult if not impossible for the beginner to control, with specific utensils like the scutch, the breaking lines of this type of enamel plate. Often, these disks are reduced into smaller fragments with the help of a glass cutter. Once workable sizes have been reached, each fragment is progressively reduced and adapted to the desired shape with the scutch.

Substantially, the realisation of a mosaic which is not made with tesseras of coloured paper but with the materials indicated above, consists of three steps:

1. In the first step the choice or creation of the subject is made, with the realisation of the design and the specification of the colours and of the various tones.

2. In the second step one proceeds to the choice of materials, which for chromatic characteristics can be compatible with the subject and one proceeds to work them to obtain the tesseras. In other words, the materials are gathered, often in variable sizes, then one proceeds to breaking them with utensils like the mosaic scutch, and they are fragmented into ever smaller pieces to obtain the tesseras of the desired size. It is clear that the task requires a lot of time, good skill, a great deal of experience and a fair amount of patience. If one then wants to use plated enamel the difficulties increase due to the type of material which requires careful attention, a lot of ability and substantial economic resources for the cost thereof.

3. In the third step one proceeds to the realisation of the mosaic with the composition of the tesseras, adopting the direct mosaic method, or to obtain a flat and more homogeneous final surface, the indirect or “reverse” mosaic method.

The technical task, as well as these and other purposes, according to the present invention are achieved by realising a tile and a procedure according to the finding.

Further characteristics and advantages of the invention shall become clearer from the description of the preferred but not exclusive embodiments of the tile and of the procedure according to the finding, where the tile is illustrated for indicating and not limiting purposes in the attached drawings, wherein:

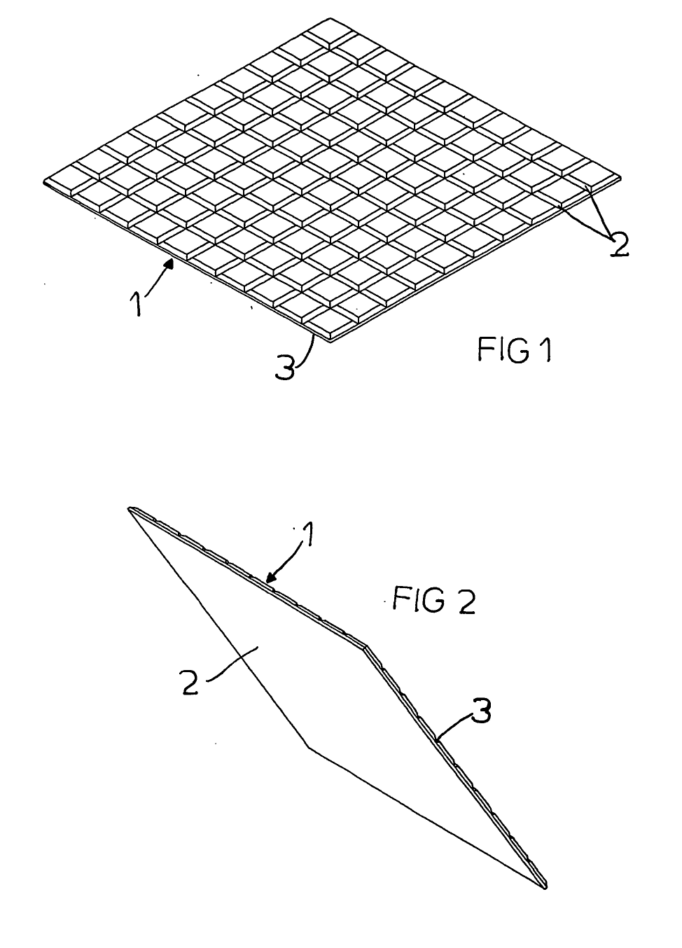

FIGS. 1 and 2 show a perspective view, front and back respectively, of the tile according to the finding.

With the tesseras according to the finding we have tried to reconcile an aesthetic look, precisely of the tesseras formed by the enamel disks, with characteristics of workability for the final user, i.e. whoever should wish to try out the art of mosaic creation, such as to allow its use even by mosaic lovers who are beginners and who have little experience. The same tesseras, object of the present description, also allow the second step in the mosaic realisation process to be reduced to the minimum. The artist, with this type of tessera, will have to put his mind to the first step (choosing or creating the subject), or the third step (realising the mosaic), and does not have to lose time in the time-consuming working, already described in the second step, in order to obtain the tesseras to measure.

The tesseras which are being proposed derive from a terracotta support 1 (FIG. 1-2) whose surface 2 (FIG. 1-2) is then glazed in a kiln. In common use the tesseras are obtained from the fragmentation of materials, chosen for their chromatic characteristics. It becomes very difficult to obtain a tessera which is perfectly square or rectangular with a front surface which is flat and homogeneous. The thickness then makes its resizing to adapt to the design incredibly difficult. With the tesseras according to the finding, on the other hand, one has extremely regular tesseras with perfectly flat surfaces. For example it becomes easy to have square or rectangular tesseras (by choice), which to keep things short we shall consider to be square and with a side of 10 mm. To obtain them, a terracotta support 1 (FIG. 1-2) is realised of a size of 100×100 mm with a thickness equal to between 1.5 and 3 mm (photo 3), which after having glazed its face 2 (FIG. 1-2) we shall call a tile. From the tile all of 100 tesseras are obtained with the measurement indicated above (equal to 10×10) with perfectly regular edges.

The tile can be obtained in different ways:

In a first example, in which the tile is realised by a craftsman, the clay paste is spread and forced into a mould of 100×100 mm and with a depth of between 1.5 and 3 mm. Then the excess paste is removed, thus obtaining a sheet. Parallel and orthogonal grooves (FIG. 1-2) are realised, using a scraper and one waits for the clay to dry up a bit. Starting to dry up, the sheet disattaches from the edges and from the base which can also be made of wood or plywood, suitably porous and absorbent to speed up the process (it is necessary and in any case helpful that the edges of the mould be separable from the base). In the drying step the tile is placed between two planes which stop it from deforming, removing any deformations which have been produced, and once dry it is fired at about 1000°, according to the requirements of the material used. The tile is then glazed on the opposite side to the one with the grooves, taking necessary care in order to restrict the glaze to the front surface avoiding the rear part.

In a second embodiment realised by a craftsman, the tile can be formed by cutting a block of clay in a regular manner, using steel wire and guides. The tiles are formed from these sheets, the thickness of which can range between 1.5 and 3 mm. Then grooves are made with a suitably calibrated disk roller on the part which shall become the rear. The subsequent steps are similar to those already described.

In a semi-industrial embodiment the realisation of the sheet from which the tile shall be obtained can also derive from a drawing procedure of the clay paste. Then the treatments already described previously shall follow.

In an industrial embodiment the tile according to the finding can be obtained with the pressing of an atomised mixture of clays at a certain humidity, using for example oleodynamic presses, specific to the field of ceramics. In this case moulds shall be used which allow the realisation of a tile where the tesseras have a uniform thickness, extremely regular grooves which are of an optimised depth for a correct breaking of the tile in order to obtain the tesseras. The tesseras obtained can be characterised by a perfect parallelness, between the glazed surface and the opposite one corresponding to the gluing zone, but said zone could be not actually parallel to the surface to be glazed or in any case not perfectly flat and/or with some irregularities, like a slightly convex surface so as to adjust the positioning of the tessera in the gluing step. This possible irregularity, in some cases, indeed, could be required to accentuate the reflections of light obtained in the realisation of mosaic panels. The moulding of the tiles could then allow a further ornamental design which is raised on the glazed surface to be created in correspondence with each tessera. Then follows the firing of the tile at about 1000° and the subsequent glazing, with the second firing according to the characteristics of the glazes used. The glazing can take place in many steps to obtain particular chromatic effects like for example in the case of glazing with zecchin gold. Through special provisions it will also be possible to realise the finding industrially with a single-firing technique.

It is obvious that the sizes of the squares realised with the crossing of the grooves 3 (FIG. 1-2), corresponding to the final tesseras, can be various. There can be tesseras with a surface of 5×5, 6×6, 7×7, 8×8, 9×9, 10×10, 11×11, 12×12, 13×13, 14×14, 15×15, and so on mm by varying the pitch of the grooves. For the successive easy workability of the final product it becomes important to contain the thickness of the tile and thus of the tessera to between 1.5 and 3 mm. The depth of the groove could be half the thickness of the tile, therefore in this case between 0.75 and 1.5 mm or also other according to the technical characteristics of the material used, to the regularity of formation of the grooves, and to the type of procedure adopted to obtain the tile.

The glazing in a kiln, on the non-grooved surface, allows all of the colours which make mosaics realised with glazes on plates precious and unique to be obtained. The chromatic variability is practically infinite. Moreover, it is advised that the size of the tile be between 50×50 mm and 100×100 mm because it becomes very difficult to calibrate its thickness, and then to proceed to the application operations of the glaze. Moreover, a size between 50×50 mm and 100×100 mm is optimal also for packaging and the realisation of boxes for consumers.

To obtain the tesseras the artist must only take the tile and proceed to breaking it applying a pressure in correspondence with the grooves 3 (FIG. 1-2) on the side of the glazed surface and an opposite force on the edges far away from the breaking line defined with the groove. The breaking becomes immediate, the edges are virtually perfect and there can be tesseras of a size equal to the distance between the grooves but also multiples. In the case of the tile with grooves with a 10 mm pitch, tesseras can be obtained with a side of 10, 20, 30 (and so on) mm. The glazing is strongly fixed to the support and practically cannot be altered by foreign agents having the properties of the ceramic. The small thickness of the tile and in particular of the terracotta support, allows an easy modification of the edges of the tesseras or an easy resizing thereof as well as adaptation thereof to the required shape.

The modification of the shape of the tessera can be carried out with small side-cutting nippers, but by equipping oneself with mosaic nippers, the tessera of 10×10 mm can be easily divided into tesseras of 5×10 mm or into 4 tesseras with a side length of 5 mm, with an incredible degree of precision. Moreover, the 10×10 tessera can easily be divided according to the diagonal or according to any direction.

As highlighted, the invention gives artists, hobbyists, students and the aged who wish to stimulate their psycho-motor capacities, new tesseras for mosaics which are easy to use, which have a definite effect, with a reduced production cost. The details, the surface and the sizes of the tesseras can vary nevertheless, without leaving the scope of the finding and therefore of the present patent document.

1. Tile for forming tesseras for mosaics, characterised in that it comprises a terracotta or ceramic support or the like having a first glazed surface, characterised in that said support has, in correspondence with a second surface opposite the first, one or more eased breaking lines, which allow said tiles to be subdivided into said tesseras with whatever shape and size.

2. Tile according to claim 1, characterised in that said support has a thickness of less than four millimetres and preferably less than three millimetres.

3. Tile according to one or more of the previous claims, characterised in that it has a thickness of between 1.5 (one point five) and three millimetres, so as to ease the breaking of the tiles and the resizing of the tesseras with readily available tools.

4. Tile according to one or more of the previous claims, characterised in that said eased breaking lines are defined by grooves having a constant depth which can be between almost one tenth of a millimetre and a measurement which is little less than the same thickness as the tile, said depth of said grooves being dependent upon the procedure used to produce the finding and upon the technical characteristics of the material used.

5. Tile according to one or more of the previous claims, characterised in that said eased breaking lines are orthogonal to each other so as to outline substantially quadrangular tesseras.

6. Tile according to one or more of the previous claims, characterised in that said eased breaking lines are oblique to each other so as to outline substantially rhomboidal tesseras.

7. Tile according to one or more of the previous claims, characterised in that said eased breaking lines are orthogonal and oblique to each other so as to outline substantially quadrangular, rhomboidal and triangular tesseras.

8. Tile according to one or more of the previous claims, characterised in that said eased breaking lines which are parallel, inclined or else orthogonal to each other have a pitch between them which differs so as to outline different shaped tesseras.

9. Tile according to one or more of the previous claims, characterised in that the tesseras outlined by said eased breaking lines have a side opposite the glazed surface which is substantially not parallel to said surface or which is convex and in any case with some irregularities in correspondence with the gluing zone so as to accentuate the reflections of light in the mosaic panels realised with the finding, determined by a non-perfect flatness and in any case by a non-homogeneity of reflection of the glazed surface of the tesseras with respect to the surface of the whole panel.

10. Tile according to one or more of the previous claims, characterised in that said tesseras outlined by said eased breaking lines have a glazed surface with raised ornamental designs such as ashlar or a convex or concave surface, etc.

11. Procedure for realising a tile for forming tesseras for a mosaic, characterised in that it consists of realising a terracotta support in the form of a sheet, of realising a plurality of grooves on a surface of the sheet so as to define eased breaking lines for the tile, of drying and then of firing the sheet and of glazing a surface of the tile opposite to the previous surface.

12. Procedure according to the previous claim, characterised in that said sheet has a thickness of less than 4 millimetres and preferably less than 3 millimetres.

13. Procedure according to one or more of claims 12 and those which follow, characterised in that during drying the tile is arranged between planes which contain deformations thereof.

14. Procedure for realising a tile for forming tesseras for a mosaic, characterised in that it consists of pressing an atomised mixture of clay at a certain humidity, using specific oleodynamic presses for industrial production in the field of ceramics.

15. Procedure according to one or more of claims 12 and those which follow, characterised in that the firing of the support takes place at about 1000° C. whereas the kiln glazing follows the specific procedures of the glazes used.

16. Use of a tile for forming tesseras for a mosaic, characterised in that it consists of separating from the tile, having a plurality of grooves in correspondence with a surface which outline a plurality of tesseras and another surface opposite the previous one which is glazed, one or more tesseras and of applying said tesseras to realise the mosaic.
